(19) United States
(12) Patent Application Publication
(10) Pub. No.: US 2008/0180482 A1
(43) Pub. Date: Jul. 31, 2008

(54) FLUSHING METHOD OF LIQUID EJECTING APPARATUS AND LIQUID EJECTING APPARATUS

(75) Inventor: Jun SHIMAZAKI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/021,910

(22) Filed: Jan. 29, 2008

(30) Foreign Application Priority Data
Jan. 31, 2007 (JP) 2007-020880

(51) Int. Cl. B41J 2/165

(52) U.S. Cl. 347/23

(57) ABSTRACT

A flushing method for a liquid ejecting apparatus for ejecting liquid from nozzles of a liquid ejecting head toward a liquid reception portion which faces a nozzle opening surface of the liquid ejecting head in order to prevent the nozzles from being clogged. The method comprises creating an electric field between the nozzle opening surface and the liquid reception portion, ejecting the liquid from a reference nozzle toward the liquid reception portion, detecting a variation in voltage when the liquid is ejected from the reference nozzle toward the liquid reception portion using electrostatic induction, changing a liquid ejecting condition for the nozzles based on the detected variation in voltage, and ejecting the liquid from the nozzles to the liquid reception portion based on the liquid ejecting condition.

### BACKGROUND

The entire disclosure of Japanese Patent Application No. 2007-020880, filed Jan. 31, 2007 is expressly incorporated herein by reference.

1. Technical Field

The present invention relates to a method of flushing the liquid in a liquid ejecting apparatus, such as an ink jet printer.

2. Related Art

Typically liquid ejecting apparatuses known in the art include a liquid ejecting head that is capable of ejecting various types of liquid as droplets from a liquid ejecting head.

One example of a liquid ejecting apparatus is an image recording apparatus, such as an ink jet printer, which includes an ink jet recording head (hereinafter, referred to as a recording head) that acts as a liquid ejecting head. The recording head is capable of discharging liquid ink droplets from nozzles or openings in the recording head onto a discharge object such as a recording sheet in order to form dots.

In addition to use as image recording apparatuses, liquid ejecting apparatus have recently been used in various types of manufacturing apparatuses for manufacturing the color filters of a liquid crystal displays.

In a typical image recording apparatus, ink stored in a liquid storage unit such as an ink tank or an ink cartridge is introduced into a pressure chamber of the recording head. Then a driving signal is applied to a pressure generation source, such as a piezoelectric vibrator, in order to generate a controlled pressure variation in the ink in the pressure chamber, which causes ink droplets to discharge from the nozzles.

The recording head is capable of increasing and decreasing the amount, weight, and volume of ink droplets discharged from the nozzles by varying the driving voltage of the driving signal supplied to the pressure generation source.

Typically, a flushing process is used in the liquid ejecting apparatuses in order to prevent the nozzles in the recording head from clogging. During this process, a portion of the ink the nozzles that has thickened due to evaporation is discharged from the recording head before a recording or printing process is started. This process ensures that the desired amount of ink is discharged form the recording head as droplets without any omissions. Japanese Patent Applications JP-A-2006-123499 and JP-A-2001-277543 describe flushing processes known in the art.

In the known liquid ejecting apparatuses known in the art, the flushing process is periodically performed during the recording (printing) process according to a scheduled and constant time interval. Typically, the process is performed after a predetermined number of discharges (such as 300 discharges) and is performed so that any thickened ink is eliminated even in the worst conditions, such as conditions where there is a high temperature (above 40° C. or low humidity (below 10%).

Because the flushing process is performed after the predetermined number of discharges, regardless of the specific operating conditions or state of the recording head, the process is sometimes performed unnecessarily. This results in a large amount of wasted ink and lesser efficiency in the recording process.

Moreover, even in other configurations where the flushing process which is performed when the paper is being fed or ejected from the apparatus, there is a large amount of wasted ink.

### BRIEF SUMMARY OF THE INVENTION

An advantage of some aspects of the invention is that the amount of liquid ejected from a liquid ejecting head during the flushing process is reduced.

One aspect of the invention is a method of flushing ejecting liquid from the nozzles of a liquid ejecting head of a liquid ejecting apparatus toward a liquid reception portion which faces a nozzle opening surface of the liquid ejecting head without contacting the nozzle opening surface, in order to prevent the nozzles from being clogged. The method comprises creating an electric field between the nozzle opening surface and the liquid reception portion, ejecting the liquid from a reference nozzle toward the liquid reception portion, the reference nozzle being formed in the nozzle opening surface so as to eject the liquid only towards the liquid reception portion, detecting a variation in voltage when the liquid is ejected from the reference nozzle toward the liquid reception portion using electrostatic induction, changing a liquid ejecting condition for ejecting liquid from the nozzles to the liquid reception portion based on the detected variation in voltage, and ejecting the liquid from the nozzles to the liquid reception portion based on the liquid ejecting condition.

Another aspect of the invention, is a liquid ejecting apparatus capable of ejecting liquid from nozzles in a nozzle opening surface of a liquid ejecting head toward a liquid reception portion, which faces the nozzle opening surface without touching the nozzle opening surface, in order to prevent the nozzles from being clogged. The liquid ejecting apparatus comprises a reference nozzle which is formed in the nozzle opening surface which is capable of ejecting the liquid to only onto the liquid reception portion, a liquid detecting unit which is capable of applying an electric field between the nozzle opening surface and the liquid reception portion and detecting a variation in voltage when the liquid is ejected from the reference nozzle to the liquid reception portion using electrostatic induction, and a flushing processing unit which is capable of changing a liquid ejecting condition based on the detected variation in voltage and ejecting the liquid from the nozzles to the liquid reception portion based on the liquid ejecting condition.

According to both aspects of the invention, the liquid ejecting condition is determined based on the variation in voltage of the electrostatic induction when the liquid is ejected from the reference nozzle toward the liquid reception portion. Since the reference nozzle only ejects the liquid during the flushing process, the liquid in the reference nozzle remains dormant longer than the remaining nozzles in the nozzle opening surface so it may assumed that the reference nozzle has the same or worse clogging problems than the remaining nozzles formed in the liquid ejecting head. Accordingly, because the liquid ejecting condition (flushing condition) is defined based on this worst case scenario, the flushing process performs the necessary flushing required to unclog all the nozzles while minimizing the amount of liquid used during each flushing process.

### BRIEF DESCRIPTION OF THE DRAWINGS

The invention will be described with reference to the accompanying drawings, wherein like numbers reference like elements.

FIG. 1 is a perspective view showing the configuration of a printer;

FIG. 2 is a cross-sectional view showing the configuration of a recording head of a printer;

FIG. 3 is a cross-sectional view showing the configuration of main components of the recording head;

FIG. 4 is a schematic view showing the configurations of the recording head, an ink cartridge and an ink droplet sensor;

FIG. 5 is a block diagram showing the electric configuration of the printer;

FIG. 6 is a view showing the configuration of a discharge pulse;

FIG. 7 is a schematic view showing nozzles formed in a nozzle opening surface;

FIG. 8 is a flowchart showing a flushing process using the ink droplet sensor;

FIGS. 9A and 9B explain a principle that an induction voltage occurs by electrostatic induction, wherein FIG. 9A is a view showing a state immediately after the ink droplets are discharged and FIG. 9B is a view showing a state in which the ink droplets are landed on an inspection region of a cap member;

FIG. 10 is a view showing an example of the waveform of a detection signal output from the ink droplet sensor; and

FIG. 11 is a schematic view showing an exemplary arrangement of a reference nozzle in the nozzle opening surface.

### DESCRIPTION OF EXEMPLARY EMBODIMENTS

Hereinafter, a flushing method of a liquid ejecting apparatus and the liquid ejecting apparatus according to a first embodiment of the invention will be described with reference to the accompanying drawings. In the present embodiment, the liquid ejecting apparatus is described as an ink jet printer, hereinafter referred to as a printer 1.

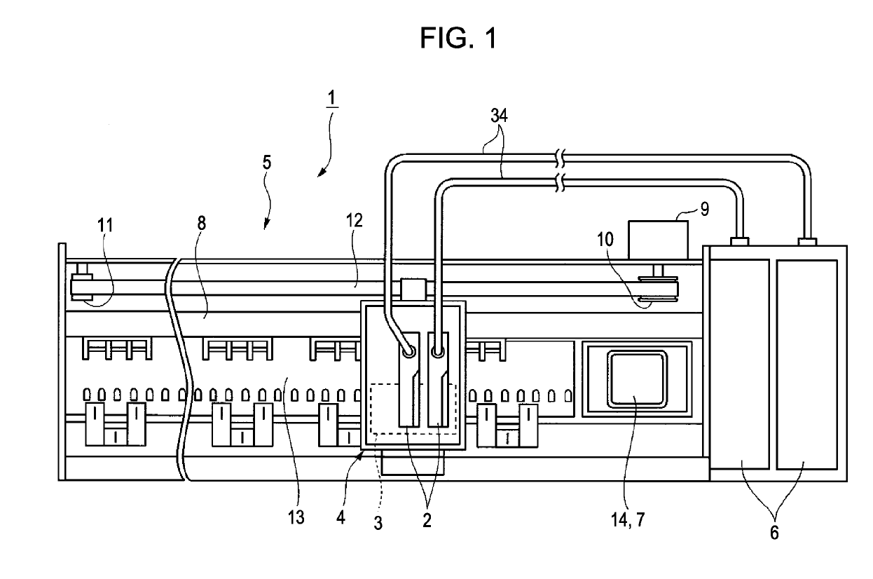

FIG. 1 is a partial exploded view showing the schematic configuration of the printer 1 according to an embodiment of the invention.

The printer 1 includes a carriage 4 and a printer main body 5. Sub tanks 2 and a recording head 3 are mounted within the carriage 4.

The printer main body 5 includes a carriage moving mechanism 65 which is capable of reciprocally moving the carriage 4, a paper transporting mechanism (not shown) which is capable of transporting recording paper, a capping mechanism 14 which is capable of sucking a thickened ink L from nozzles of the recording head 3 during a cleaning operation, and an ink cartridge 6 that is capable of storing the ink L supplied to the recording head 3.

The printer 1 further includes an ink droplet sensor 7 for detecting ink droplets D discharged from the recording head 3. The ink droplet sensor 7, described more fully below, is capable of charging the ink droplets D discharged from the recording head 3 and outputs a voltage based on electrostatic induction that varies when the charged ink droplets D fly, that may be used as a detection signal.

The carriage moving mechanism 65 includes a guide shaft 8 installed in a width direction of the printer main body 5, a pulse motor 9, a driving pulley 10 which is connected to a rotation shaft of the pulse motor 9 and is rotated by the pulse motor 9, a free-rolling pulley 11 which is provided opposite to the driving pulley 10 in the width direction of the printer main body 5, and a timing belt 12 which connected to the carriage 4 and is stretched between the driving pulley 10 and the free-rolling pulley 11.

Thus, the carriage 4 may be reciprocally moved in a main scanning direction along the guide shaft 8 by driving the pulse motor 9.

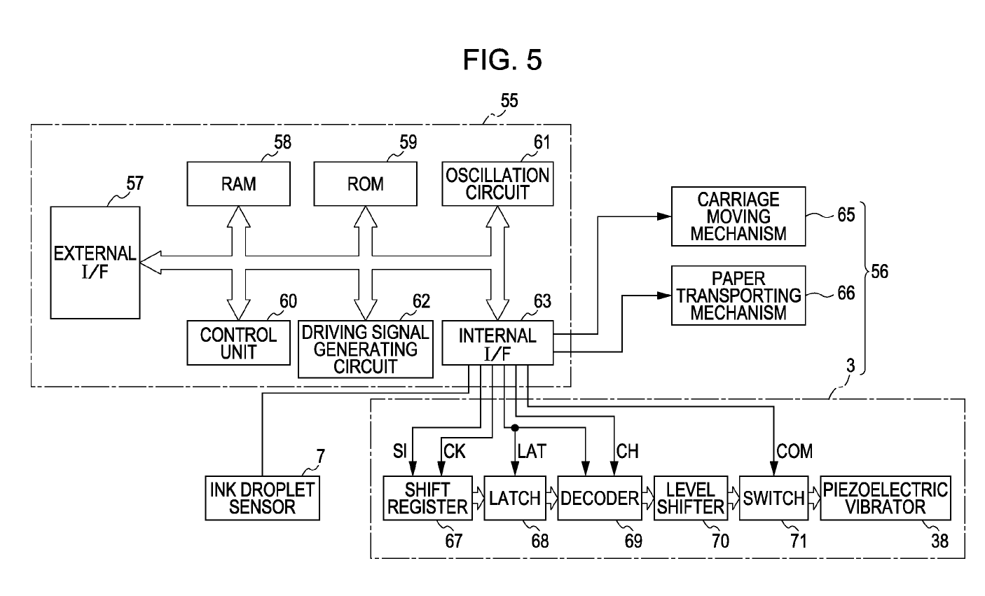

The paper transporting mechanism is described more fully below with reference to FIG. 5. The paper transporting mechanism includes a paper transporting motor (not shown) and a paper transporting roller (not shown) which is capable of being rotated by the paper transporting motor in order to transport the recording paper to a platen 13 during a recording (printing) operation.

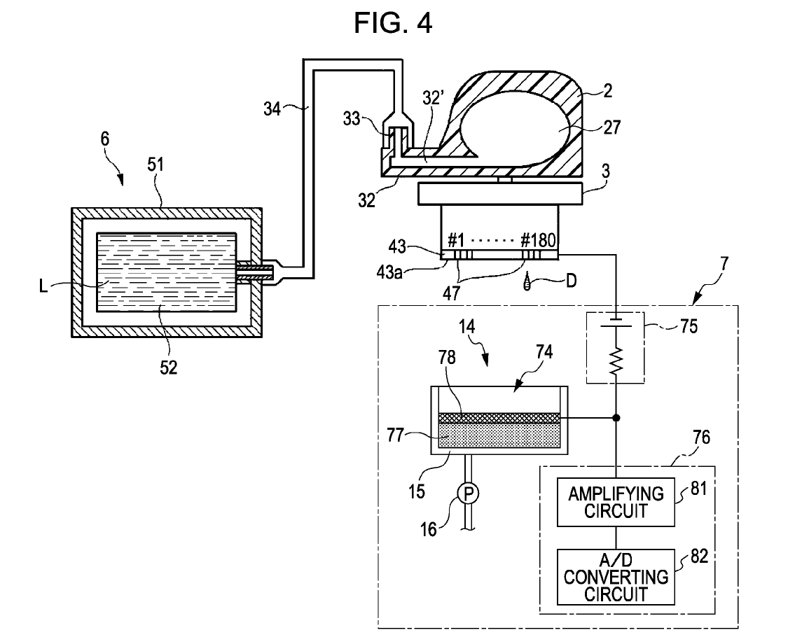

As shown in FIG. 4, the capping mechanism 14 includes a cap member 15 and suction pump 16. The cap member 15 is arranged at a home position and is obtained by molding an elastic material, such as rubber, into a tray shape that corresponds to the shape of the recording head 3. The home position is within the movement range of the carriage 4 and in this configuration is set at one end of the recording region. The carriage 4 is positioned at the home position when power is not supplied to the carriage or when a recording process has not been performed for a long period of time.

When the carriage 4 is positioned at the home position, the cap member 15 is brought in contact with a nozzle opening surface 43a of a nozzle substrate 43 of the recording head 3 so as to seal the nozzles in the nozzle opening surface. When the suction pump is operated when the nozzles are sealed, the space inside of the cap member 15 is decompressed and the ink L in the recording head 3 is forcedly discharged from the nozzles 47.

The cap member 15 collects the ink droplets D that are discharged during the flushing process, and discharges any thickened ink L or bubbles in the nozzles before or during the recording operation of the recording head 3.

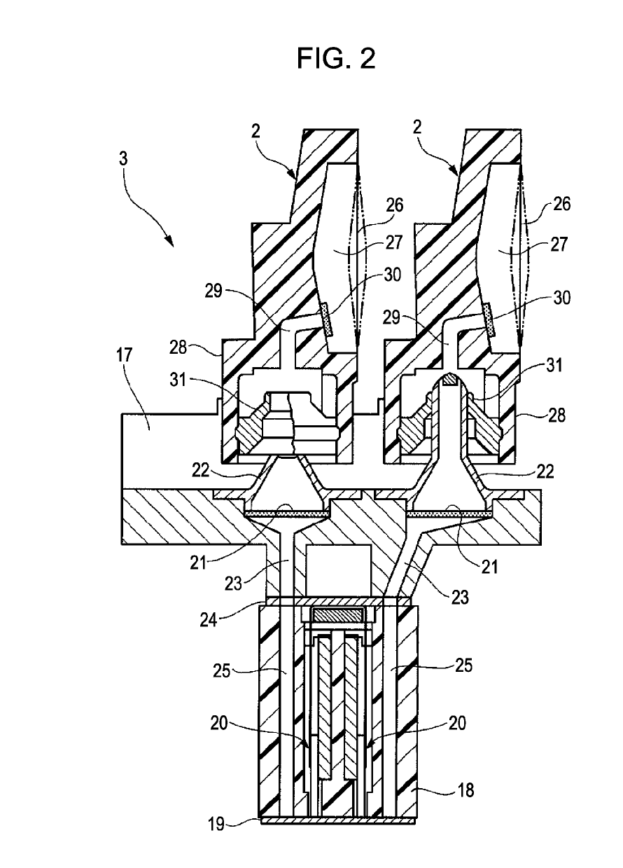

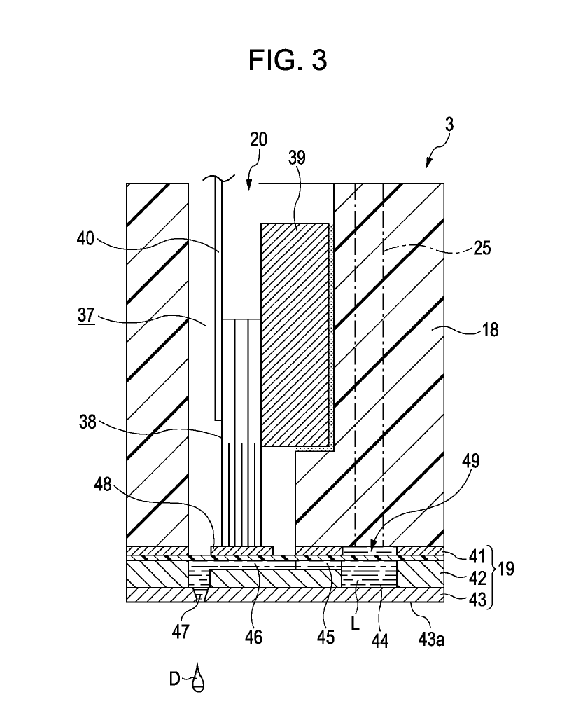

FIG. 2 is a cross-sectional view showing the configuration of the recording head 3, while FIG. 3 is a cross-sectional view showing the main components of the recording head 3, and FIG. 4 is a schematic view showing the configurations of the recording head 3, the ink cartridge 6 and the ink droplet sensor 7.

The recording head 3 according to the present embodiment includes an introduction needle unit 17, a head case 18, a passage unit 19 and an actuator unit 20 as main components.

Two ink introduction needles 22 are both mounted in a parallel manner on filters 21 which are located on an upper surface of the introduction needle unit 17. The sub tanks 2 are mounted in the ink introduction needles 22. In the introduction needle unit 17, ink introduction paths 23 are formed which correspond to the ink introduction needles 22.

The upper ends of the ink introduction paths 23 communicate with the ink introduction needles 22 through the filter 21 while the lower ends thereof communicate with case passages 25 formed in the head case 18 through a packing 24.

In this configuration, two types of ink are used, so there are two sub tanks 2 in the recording head 3. As may be understood by one of skill in the art, however, the invention may be used in any number of configurations, including those wherein three or more types of inks are used.

The sub tank 2 is made of a resin material such as polypropylene. A concave portion of the sub tank 2 is partitioned into an ink chamber 27 by attaching a transparent elastic sheet 26 to the opened surface of the concave portion.

The ink introduction needle 22 is inserted into a needle connection portion 28 which protrudes from the lower side of the sub tank 2. The ink chamber 27 in the sub tank 2 has a shallow cone shape. The upper opening of the connection passage 29 which communicates with the needle connection portion 28 is formed in the side surface of the ink chamber 27 towards the downstream portion of the ink chamber 27. In addition, a tank filter 30 for filtering the ink L is mounted at the upper opening so as to filter the ink before it enters the connection passage 29.

The ink introduction needle 22 is fitted into the inner space of the needle connection portion 28 so as to form a liquid-tight fitting. As shown in FIG. 4, an extension portion 32 has a communication groove 32′ which communicates with the ink chamber 27 of the sub tank 2 and an ink inlet 33 which protrudes from the upper surface of the extension portion 32.

An ink supply tube 34 which is capable of supplying the ink L stored in the ink cartridge 6 is to the sub tank 2 is connected to the ink inlet 33. Accordingly, the ink L passing through the ink supply tube 34 flows from the ink inlet 33 into the ink chamber 27 through the communication groove 32′.

The elastic sheet 26 can be deformed so as to expand or contract depending on the pressure in the ink chamber 27. Thus, the elastic sheet 26 is able to dampen and absorb the pressure variation of the ink L. That is, the sub tank 2 functions as a pressure dampener by the action of the elastic sheet 26. Accordingly, the pressure variation that occurs when the ink L is supplied to the recording head 3 is absorbed in the sub tank 2.

The head case 18 has a hollow box shape made of synthetic resin. The passage unit 19 is adhered to a lower end surface of the head case 18, while the actuator unit 20 is disposed in a space 37 formed within the head case 18, and the introduction needle unit 17 is mounted to an upper surface of the head case 18 that is opposite to the passage unit 19, wherein the packing 24 is disposed between the upper surface of the head case 18 and the introduction needle unit 17.

The case passages 25 are provided in a vertical direction in the head case 18. The upper ends of the case passages 25 communicate with the ink introduction paths 23 of the introduction needle unit 17 through the packing 24.

The lower ends of the case passages 25 communicate with a common ink chamber 44 in the passage unit 19. Accordingly, the ink L from the ink introduction needles 22 is supplied to the common ink chamber 44 through the ink introduction paths 23 and the case passages 25.

The actuator unit 20 located in the space 37 of the head case 18 includes a plurality of piezoelectric vibrators 38 that are arranged in a comb tooth shape, a fixing plate 39 to which the piezoelectric vibrators 38 are adhered, and a flexible cable 40 that functions as a wiring member for sending driving signal from the printer main body to the piezoelectric vibrators 38. One end of each of the piezoelectric vibrators 38 are adhered to the fixing plate 39 and while the remaining unattached ends protrude outward from a front end surface of the fixing plate 39.

In one embodiment, the fixing plate 39 made of stainless steel having a thickness of about 1 mm. The actuator unit 20 is fixed in the space 37 by adhering a rear surface of the fixing plate 39 to the inner wall surface of the head case 18, so as to partition the space 37.

The passage unit 19 is manufactured by integrally stacking and adhering a plurality of passage unit configuring members including a vibration plate (sealing plate) 41, a passage substrate 42, and the nozzle substrate 43 with an adhesive so as to form a series of ink passages that supply ink from the common ink chamber 44 to nozzles 47 through an ink supply port 45 and a pressure chamber 46. The pressure chamber 46 is formed as an elongated chamber that extends in a direction that is perpendicular to the rows of nozzles 47. The common ink chamber 44 communicates with the case passage 25 and receives the ink L from the ink introduction needles 22.

The ink L introduced into the common ink chamber 44 is supplied to pressure chamber 46 through the ink supply port 45.

The nozzle substrate 43 positioned at the bottom of the passage unit 19 is comprised of a thin plate of metal, in which the plurality of nozzles 47 are formed in a row at a predetermined pitch (for example, 180 dpi) which corresponds to a dot formation density. The nozzle substrate 43 of one embodiment is made of stainless steel and has 22 rows of nozzles 47 that are arranged so as to correspond with the sub tanks 2. One nozzle row is, for example, composed of 180 nozzles 47, as shown in FIG. 7.

The passage substrate 42 disposed between the nozzle substrate 43 and the vibration plate 41 is shaped like a plate with passage portions which become the ink passage, comprised of the common ink chamber 44, the ink supply port 45 and the pressure chamber 46.

In the present embodiment, the passage substrate 42 is manufactured by anisotropically etching a silicon wafer which is a base material having crystalline structure. The vibration plate 41 is a composite plate obtained by laminating an elastic film on a support plate made of metal such as stainless steel. An island portion 48 that is adhered to the front surfaces of the piezoelectric vibrators 38 is formed so as to correspond to the pressure chamber 46 of the vibration plate 41. The island portion 28 is formed by removing the support plate surrounding the island portion 28 in an etching process, so that the island portion 28 functions as a diaphragm to the pressure chamber 46. That is, the vibration plate 41 is configured such that the elastic film in the vicinity of the island portion 48 may be elastically deformed according to the operations of the piezoelectric vibrators 38. The vibration plate 41 seals an opening surface of the passage substrate 42 and also functions as a compliance portion 49. In order to form the compliance portion 49 of only elastic film, the support plate is removed in an etching process, similar to the process used to form the diaphragm portion.

When the driving signal is supplied to the piezoelectric vibrators 38 of the recording head through the flexible cable 40, the piezoelectric vibrators 38 expand and contract and the island portion 48 is moved closer or further away from the pressure chamber 46. Accordingly, the volume of the pressure chamber 46 varies, causing a variation of pressure in the ink L in the pressure chamber 46. By the varying the pressure, the ink droplets D are discharged from the nozzles 47.

As shown in FIG. 4, the ink cartridge 6 includes a case member 51 shaped like a hollow box and an ink pack 52 which is formed of a plastic material. The ink pack 52 disposed in a reception chamber in the case member 51.

The ink cartridge 6 communicates with one end of the ink supply tube 34 so as to supply the ink L in the ink pack 52 to the recording head 3 using a difference in pressure the nozzle opening surface 43a of the recording head 3 and the ink pack. More specifically, the relative positions between the ink cartridge 6 and the recording head 3 utilizes gravitational pull of the ink to create a slight negative pressure at the meniscus of the nozzles 47.

The supply of the ink L to the pressure chamber 46 shown in FIG. 3 and the discharge of the ink L from the pressure chamber 46 is performed by varying pressure in the pressure chamber 46 by driving the piezoelectric vibrators 38.

As shown in FIG. 4, the ink droplet sensor 7 includes the cap member 15 positioned at the home position which functions as receptacle for receiving liquid droplets, an inspection region 74 provided in the cap member 15, a voltage applying circuit 75 for applying a voltage between the inspection region 74 and the nozzle substrate 43 of the recording head 3, and a voltage detection circuit 76 for detecting the voltage of the inspection region 74.

The cap member 15 is a tray-shaped member having an opened upper surface and is made of an elastic material such as an elastomer. An ink absorber 77 is arranged in the cap member 15. The ink absorber 77 is made of a material that is highly capable of capturing and storing the ink L and is, for example, made of nonwoven fabric such as felt.

A mesh-shaped electrode member 78 is arranged on the upper surface of the ink absorber 77. The surface of the electrode member 78 corresponds to the inspection region 74. The electrode member 78 is made of metal such as stainless steel and in one embodiment is formed as a lattice-shaped mesh. Accordingly, the ink droplets D landed on the electrode member 78 may be absorbed and stored in the absorber 77 positioned below the electrode member 78. Thus, the ink droplets D are able to travel through the gaps of the lattice-shaped electrode member 78 to the absorber 77.

The voltage applying circuit 75 includes a DC power source, which operates at a predetermined voltage, such as 400 V, and a resistor that operates at a predetermined resistance, such as 1 MΩ so as to electrically connect the electrode member and the nozzle substrate. Thus, the electrode member 78 has a positive polarity and the nozzle substrate 43 of the recording head 3 has a negative polarity.

The voltage detection circuit 76 includes an amplifying circuit 81 for amplifying and outputting the voltage signal of the electrode member 78 and an A/D converting circuit 82 for A/D converting the signal output from the amplifying circuit 81 and outputting the converted signal to a printer controller 55. The amplifying circuit 81 amplifies the voltage signal of the electrode member 78 by a predetermined amplification factor and outputs the amplified signal. The A/D converting circuit 82 converts the analog signal output from the amplifying circuit 81 into a digital signal and outputs the digital signal to the printer controller 55 as a detection signal.

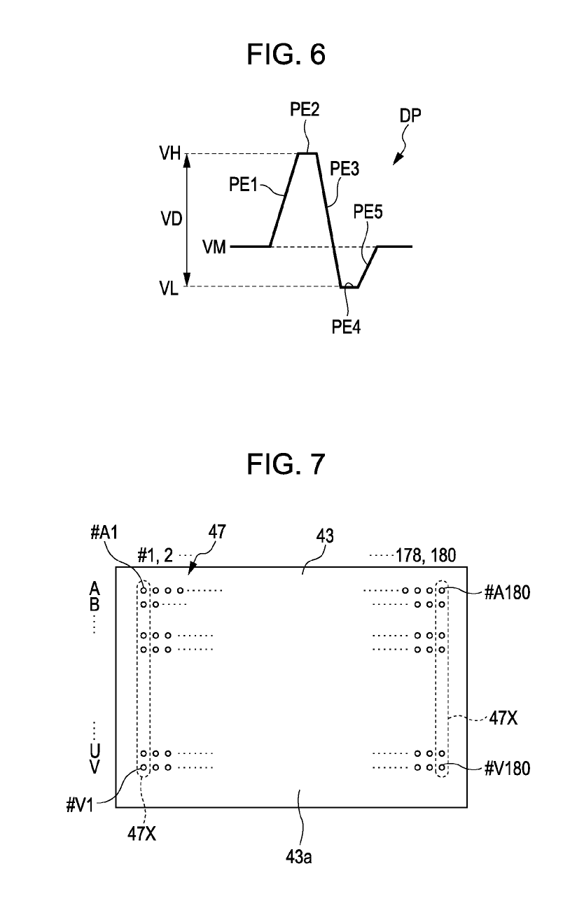

FIG. 5 is a block diagram showing the electric configuration of the printer 1 and FIG. 6 is a view showing the configuration of a discharge pulse.

The printer 1 according to the present embodiment includes the printer controller 55, a print engine 56 and the ink droplet sensor 7.

The printer controller 55 includes an external interface (external I/F) 57 for receiving print data from an external device such as a host computer, RAM 58 for storing a variety of data, ROM 59 for storing control programs for a variety of controls, a control unit 60 for overall controlling the components according to the control programs stored in the ROM 59, an oscillation circuit 61 for generating a clock signal, a driving signal generating circuit 62 for generating the driving signal supplied to the recording head 3, and an internal interface (internal I/F) 63 for outputting the driving signal or discharge data obtained by developing the print data for each dot to the recording head 3.

The printer engine 56 includes the recording head 3, a carriage moving mechanism 65 and a paper transporting mechanism 66.

The recording head 3 includes a shift register 67 for setting the discharge data, a latch circuit 68 for latching the discharge data set by the shift register 67, a decoder 69 for analyzing the discharge data from the latch circuit 68 and generating pulse selection data, a level shifter 70 capable of functioning as a voltage amplifier, a switch circuit 71 for controlling the supply of the driving signal to the piezoelectric vibrators 38, and the piezoelectric vibrators 38.

The control unit 60 develops the print data received from the external device to the discharge data which corresponds to the desired dot pattern and transmits the discharge data to the recording head 3. The recording head 3 discharges the ink droplets D on the basis of the received discharge data.

The control unit 60 functions as a flushing unit for performing flushing processes based on a flushing condition stored in the ROM 59. The flushing process prevents the nozzles from being clogged by discharging any thickened ink L or bubbles from the nozzles 47 of the recording head 3. During this process the ink droplets D are discharged from the nozzles 47 toward the cap member 15 several times.

The flushing process is typically performed before printing, meaning that the flushing process is performed before power is applied to the printer 1 and the recording operation is started. Typically, in a flushing process performed before printing, the ink droplets D are discharged from all the nozzles 47 between 3000 to 5000 times. Then, the flushing condition is stored in the ROM 59.

The number of times the ink is discharged from the nozzles 47 during the flushing process before printing is set in order to prevent the nozzles 47 from being clogged by thickened ink L that has accumulated as a portion of the ink L evaporates when the printer 1 is not used for several months (a worst condition).

In addition, the number of times that ink is discharged during the flushing process is an initial value that is set when power is applied to the printer 1, but may be changed to another number in order to optimize the flushing process when the process is actually performed.

In addition to the flushing before printing processes, additional flushing process may be performed periodically during the recording operation using the recording head 3. Additional flushing operations may be performed when the recording paper is fed toward the recording head 3 and when the paper is ejected immediately after the recording paper is discharged.

During these periodical flushing processes, the initial value of the number of times that the ink is discharged from the nozzles 47 may be set to between several dozen to several hundreds of times, such as 144 times.

In the periodical flushing processes, a time interval for the periodical flushing process, referred to as a periodical flushing time interval, is set as the flushing condition and may be, for example, 1 hour.

The driving signal generating circuit 62 receives data indicating a variation in voltage in a discharge pulse supplied to the piezoelectric vibrators 38 of the recording head 3 along with a timing signal for defining the timing of varying the voltage of the discharge pulse. The driving signal generating circuit 62 receives then generates the driving signal including the discharge pulse DP shown in FIG. 6 on the basis of the data and the timing signal.

The discharge pulse DP includes a first charging element PE1 for increasing the voltage from a reference voltage VM to a highest voltage VH at a relatively gentle gradient, a first hold element PE2 for holding the highest voltage VH for a predetermined period of time, a discharging element PE3 for decreasing the voltage from the highest voltage VH to a lowest voltage VL at a steep gradient, a second hold element PE4 for holding the lowest voltage VL for a short period of time, and a second charging element PE5 for returning the voltage from the lowest voltage VL to the reference voltage VM.

The discharge pulse DP is set to a driving voltage VD (a difference between the highest voltage VH and the lowest voltage VL) in which the amount of ink droplets D discharged from the nozzles 47 is equal to a predetermined amount. In addition, the discharge pulse DP is not limited to the waveform shown in FIG. 6, and various waveforms may be used.

When the discharge pulse DP is applied to the piezoelectric vibrators 38, the ink droplets D are discharged. That is, when the first charging element PE1 is supplied, the piezoelectric vibrators 38 contract and the pressure chamber 46 expands. The expanded volume of pressure chamber 46 is held during a very short time period, after which the discharging element PE3 is applied causing the piezoelectric vibrators 38 to rapidly expand. Accordingly, the volume of the pressure chamber 46 is reduced to less than the reference volume, or the volume of the pressure chamber 46 when the reference voltage VM is applied to the piezoelectric vibrators 38, causing the meniscus of the ink in the nozzles 47 to expand outward. Therefore, a small amount of ink droplets D are discharged from the nozzles 47. Thereafter, the second hold element PE4 and the second charging element PE5 are sequentially supplied to the piezoelectric vibrators 38 and the pressure chamber 46 is returned to the reference volume, which quickly dampens the vibration of the meniscus due to the discharge of the ink droplets D.

FIG. 7 is a schematic view showing the nozzles 47 formed in the nozzle opening surface 43a. In this example, 22 rows of 180 nozzles 47 (total 3960) are formed in the nozzle opening surface 43a. In addition, the nozzle rows are represented by A to V and the nozzle numbers of the nozzle rows are represented by 1 to 180.

The 3960 nozzles 47 can discharge all the ink droplets D. However, the nozzles 47 located at each end of the rows of nozzles (A1, A180, B1, B180, . . . V1, and V180) which are herein referred to as reference nozzles 47X are controlled so as to discharge ink droplets D toward the cap member 15 of the ink droplet sensor 7. In other words, the reference nozzles only discharge ink droplets D during the flushing process and do not discharge the ink droplets D onto the recording paper.

The reference nozzles 47X are used to detect the viscosity of the ink L. Since the reference nozzles 47X discharge the ink droplets D only during the flushing process, the ink L remains dormant in the reference nozzles 47 the longest amount of time, meaning that the reference nozzles 47 have ink L with the greatest viscosity out of all the 3960 nozzles 47.

Additionally, since the reference nozzles 47X are arranged in the outer region of the nozzle opening surface 43a, the ink L becomes thickened more quickly than compared to the nozzles 47 in the central region. In the central region, a plurality of other nozzles 47 (each of which houses a meniscus of ink L) are arranged close together, meaning that the liquid in each of the nozzles 47 increases the humidity in the area, making it the nozzles in the central area more resistant to evaporation. In contrast, the reference nozzles 47X are on the edge of the nozzle opening surface 43a, causing them to be more susceptible to evaporation.

The printer 1 having the above-described configuration performs a periodical flushing process at each predetermined interval. During the periodical flushing process, the thickened state of the ink L at the reference nozzles 47X determines the level of flushing that is performed on the remaining nozzles 47. Thus, the flushing conditions are optimized and modified based on the detection signal of the ink droplet sensor 7 when the ink droplets D are discharged from the reference nozzles 47X. Using the detection signal, ink droplets D are continuously discharged from all the remaining nozzles 47 during the flushing process.

Hereinafter, a case of performing the periodical flushing process will be described.

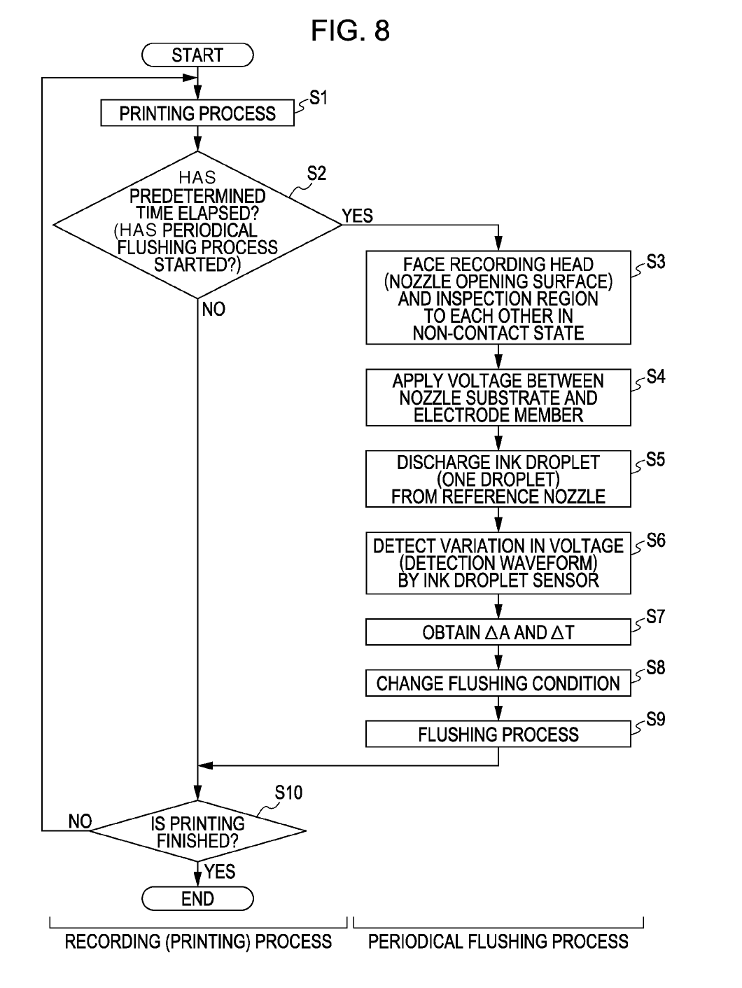

FIG. 8 is a flowchart illustrating the flushing process using the ink droplet sensor 7.

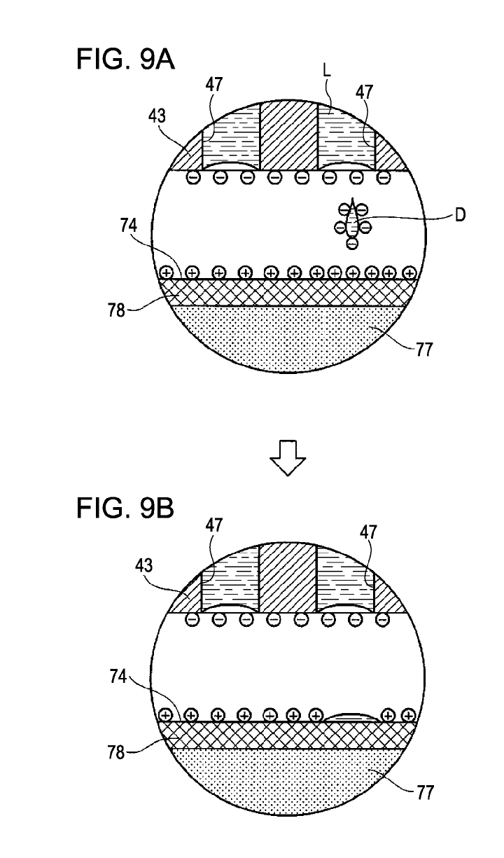

FIGS. 9A and 9B illustrate an induction voltage that may occur by electrostatic induction. FIG. 9A illustrates the state immediately after the ink droplets D have been discharged and FIG. 9B is a view showing the ink droplets D that have landed on the inspection region 74 of the cap member 15.

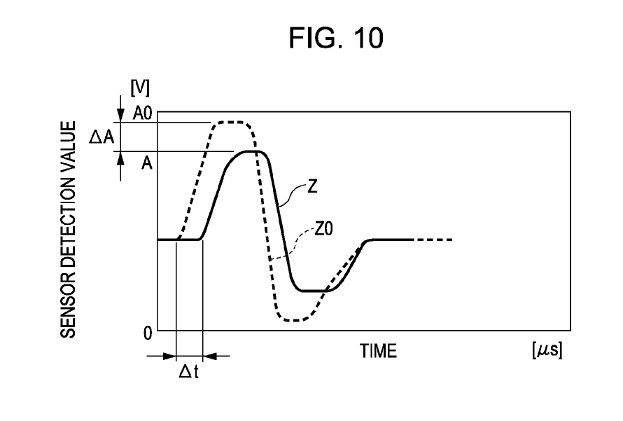

FIG. 10 is a view showing an example of a waveform of the detection signal (one ink droplet) output from the ink droplet sensor 7.

First, when the print data is transmitted to the control unit 60 from the external device, the control unit 60 converts the print data into discharge data which corresponds to a dot pattern and transmits the discharge data to the recording head 3. Upon receiving the discharge data, the recording head 3 performs the recording or printing process S1, that is, the recording head 3 discharges ink droplets D onto the recording paper in a manner corresponding to the received discharge data.

Next, it is determined S2 if the predetermined time between the periodical flushing time intervals has elapsed since the last the recording process. If it is determined that the predetermined period of time has elapsed, the recording process is stopped and the periodical flushing process is started.

During the periodical flushing process, the carriage 4 is driven and the recording head 3 is moved to the home position above the cap member 15.

Next, the cap member 15 is lifted by an elevation mechanism (not shown), and the nozzle opening surface 43a of the recording head 3 and the inspection region 74 (electrode member 78) are made so as to face S3 each other without making contact.

Then, a voltage is applied S4 between the nozzle substrate 43 and the electrode member 78 by the voltage applying circuit 75.

When the voltage is applied between the nozzle substrate 43 and the electrode member 78, the piezoelectric vibrators 38 of the reference nozzles 47X are driven using the discharge pulse DP and an ink droplet D is discharged S5 from any one (for example, #A1) of the reference nozzles 47X.

As shown in FIG. 9A, since the nozzle substrate 43 has a negative polarity, the negative charges of a portion of the nozzle substrate 43 are moved to the ink droplet D, causing the discharged ink droplet D to have a negative polarity. As the ink droplet D approaches the inspection region 74 of the cap member 15, the number of the positive charges is increased in the inspection region 74 (surface of the electrode member 78) by the electrostatic induction.

Thus, the voltage between the nozzle substrate 43 and the electrode member 78 is higher than the initial voltage value in a state in which the ink droplet D has not been discharged, due to the electrostatic voltage which occurs by the electrostatic induction.

Then, as shown in FIG. 9B, when the ink droplet D lands on the electrode member 78, and a portion of the positive charges of the electrode member 78 are neutralized by the negative charges of the ink droplet D. Accordingly, the voltage between the nozzle substrate 43 and the electrode member 78 is lower than the initial voltage value.

Thereafter, the voltage between the nozzle 43 and the electrode member 78 is returned to the initial voltage value.

Accordingly, as shown in FIG. 10, the voltage rises in the detection waveform output from the ink droplet sensor 7. The voltage in the detection waveform output then drops to less than the initial voltage value, and returns to the initial voltage value.

The difference in voltage when the ink droplet D is discharged from the reference nozzle 47X (for example, #A1) is detected S6 by the ink droplet sensor 7.

During this process, if the ink droplet D has thickened due to evaporation, the amount of liquid discharged by the recording head 3 is smaller than discharged during a normal discharge, even though the same discharge pulse DP is used.

FIG. 10 illustrates a detection waveform Z that may be output from the ink droplet sensor 7 when the ink droplet D is thicker than normal. The amplitude A of the solid waveform Z is smaller than the amplitude A0 of the detection signal of the standard waveform Z0 that may normally be outputted when the ink droplets D has not thickened. The difference in amplitude is referred to as ΔA. Moreover, the amount of time between when the discharge pulse DP is applied and when the ink droplet D is separated from the nozzle substrate 43 is longer than in the standard waveform Z0, the timing being shifted by a time difference ΔT.

Accordingly, the amplitude A or timing of the waveform Z output from the ink droplet sensor 7 varies from the ideal waveform Z0, by ΔA and ΔT, meaning that the thickened state of the ink L in the reference nozzle 47X (for example, #A1) of the recording head 3 may be detected by detecting ΔA and ΔT S7.

As described above, since the number of reference nozzles 47X is total 44 (22 rows×2), the ink droplets D may be sequentially tested for each of the reference nozzles 47X such that the thickened state of the ink L at all the reference nozzles 47X may be obtained.

When the status of the ink L at all the reference nozzles 47X is obtained, the ink L which is most thickened is selected as a reference and information on the ink L which is in a worst thickened state is used in the subsequent processes.

As described above, in the current art, the number of times that ink is discharged during the periodical flushing is defined so as to alleviate the worst possible case, when the printer has been dormant for a long period of time and the thickened state of the ink L in the nozzles 47 is at its worst.

However, in most situations, the actual status of the ink L is will not at the worst possible state. Accordingly, in the present invention, the actual state of the ink L is detected or estimated and number of times that the liquid ink L is discharged during the flushing process is set according to the detected thickness of the liquid, resulting in a smaller number of discharges during the flushing process and less wasted ink L.

Accordingly, during the recording process of the recording paper, the flushing condition is changed S8 to compensate for the most thickened ink in the reference nozzles 47X.

One method of determining the flushing condition, for example, is by detecting the relationship between the viscosity of the ink L and the number discharges required to prevent the nozzles from being clogged. By performing a number of experiments, this information may be detected and stored in the ROM 59.

For example, if the ink L has ten times the thickness of a standard drop of ink L is detected by a waveform Z by the ink droplet sensor 7, a reference table may be used to determine the number of times that the discharge should be performed to correspond to the measured thickness, and that number may be defined as the new number of times of that the ink should be discharged from the nozzles 47 during the flushing operation.

For example, the ink L at each of the reference nozzles 47X has not thickened, the flushing operation may only discharge ink L from the nozzles 47 ten times.

If the flushing condition is changed, the flushing process in which the ink droplets D are continuously discharged from the non-reference nozzles 47 is performed S9 based on the new flushing condition.

As described above, in the recording heads of the previous art, ink droplets D were discharged from all the nozzles 47 a predetermined number of times, such as 144 times. Thus, one advantage of the present invention is that the number of times that ink is discharged from the nozzles 47 during the flushing process is reduced, such as only ten times. Accordingly, less ink L is wasted by the flushing process is while preventing the nozzles from being clogged.

In addition, the ink droplets D may also be continuously discharged from the reference nozzles 47X during the flushing process S9.

If it is determined S10 that the periodical flushing process is finished, the recording process is resumed. During the recording process, the system repeatedly determines whether the periodical flushing process should be performed S2 and whether the recording process is finished S10.

As described above, in the printer 1 of the present invention the ink droplet sensor 7 is used for detecting the thickness of the ink droplets D discharged from the reference nozzles 47X in order to create a detection signal that is used to optimize the flushing conditions so that ink droplets D are not vainly discharged during flushing process.

Since the viscosity state of the ink L in the nozzles 47 is obtained by measuring the amplitude or the timing of the detection waveform Z from the ink droplet sensor 7, the flushing conditions can be optimized, while the nozzles can be prevented from being clogged due to the thickening of the ink L, and the amount of wasted ink L can be minimized.

In addition, if the ink L in the reference nozzles 47X is thicker more than expected, the flushing condition is set with a greater number of discharges. Accordingly, in the event that the ink requires a large number of discharges, the process will use an even greater number of discharges than used in systems of the current art. Thus, the amount of ink L which is wasted by the flushing process cannot be minimized but the nozzles can be prevented from being clogged.

In comparison, in printers of the related art, if the periodical flushing process fails to successfully unclog the nozzles, a troublesome cleaning process is performed. In the present embodiment, however, the periodical flushing process is more reliable, meaning that the cleaning process may not be required.

Although, in the above-described embodiment, the number of times of discharge of the ink droplets D is changed (optimized) to meet the appropriate flushing conditions, in another embodiment the discharge pulse DP or the periodical flushing time interval may be changed.

The discharge pulse DP is set at the time of the recording or printing as at initial value. Then, during the flushing process, the driving voltage VD of the discharge pulse DP may be changed according to the thickness of the ink droplets D using the detection signal of the ink droplet sensor 7. That is, when the viscosity of the ink L is large, the driving voltage VD increases and, if the viscosity degree of the ink L is small, the driving voltage VD decreases.

In this example, although the number of times that the ink droplets D are discharged is constant (for example, 144), the amount of the ink L which is wasted by the flushing process can be minimized, while the nozzles can be prevented from being clogged.

In addition, the initial value of the periodical flushing time interval may be set to, for example, 1 hour.

Then, the periodical flushing time interval may increase or decrease S8 depending on the thickness of the ink droplets D discharged from the reference nozzles 47X during the flushing process. That is, if the viscosity of the ink L is large, the periodical flushing time interval decreases, perhaps to 30 minutes, while if the viscosity of the ink L is small, the periodical flushing time interval may increases to 2 hours.

If the periodical flushing time interval is changed, the time until the next periodical flushing process is changed. Accordingly, if the viscosity of the ink L in the reference nozzles 47X is better than expected, the number of times that the recording process is interrupted due to the periodical flushing process can be reduced.

Accordingly, although the number of times that the ink droplets D are discharged during each flushing process remains constant, the number of processes and the amount of ink L which is wasted by each flushing process can be minimized, while the nozzles remain unclogged.

In another embodiment, the number of times that the ink droplets D are discharged during each flushing process, the discharge pulse DP between the periodical flushing processes may both be changed. Using this process, the nozzles can be prevented from being clogged while the amount of wasted ink L can be minimized and the number of interruptions during the recording process due to the periodical flushing process can be reduced. Thus, the efficiency of the recording process can be increased.

In addition to the above-described embodiments, and various suitable examples of the invention previously described, there are various modifications to the invention that are not limited to these examples. Various modifications can be made on the basis of claims.

For example, although the invention is described with reference to a periodical flushing process, the invention is not limited to this and other flushing process may be performed in association with the present invention. Thus, the invention is applicable to flushing operations that take place before printing, flushing processes that are performed upon the feeding of the paper, and the flushing processes that are performed upon the ejection of the paper.

In particular, when the invention is applied to a flushing process that occurs before a printing process, the amount of wasted ink L can be significantly suppressed and the nozzles can be prevented from being clogged.

When the invention is applied to the flushing process upon the feeding of the paper upon the ejection of the paper, the amount of wasted ink L can be minimized and the nozzles can be prevented from being clogged.

In addition, in the embodiment described above, a plurality of reference nozzles 47X are used to determine the thickness of the ink L, although the invention is not limited to this.

In another embodiment of the invention, the flushing conditions may be changed for each of the nozzle rows A to V according to the types of ink that are used. For example, if a plurality of different inks, such as the six colors that are typically used, are discharged from various rows of nozzles, an optimal flushing process can be performed that is specific to the types of ink. Since the composition of the ink varies according to the color, the thickness and viscosity will vary according to the color. Accordingly, even in printing apparatuses where a plurality of inks are used, the flushing conditions may be optimized for each nozzle row, minimizing amount of wasted ink while preventing the nozzles from clogging.

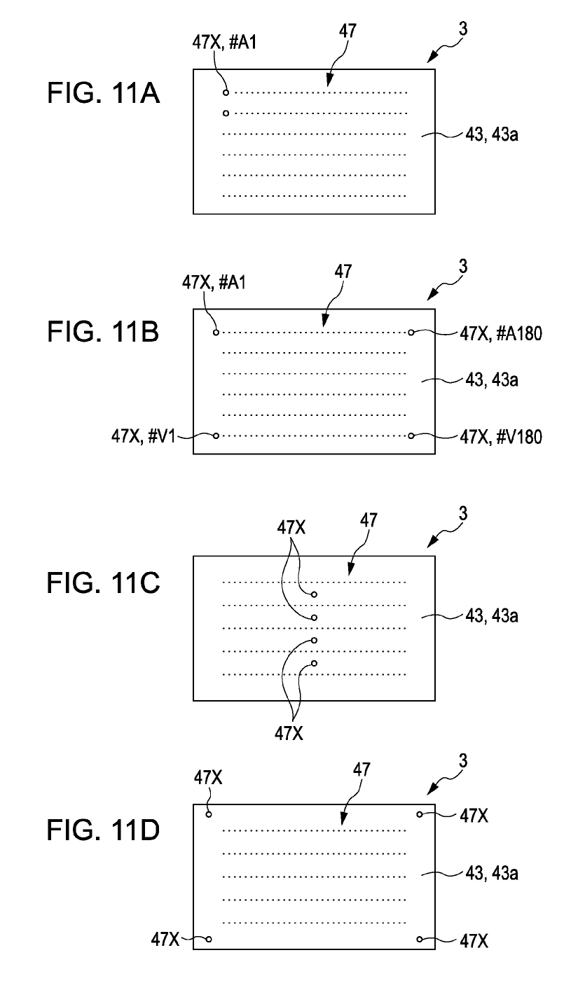

FIGS. 11A-11D are schematic views showing various arrangements of the reference nozzles 47X in the nozzle opening surface 43a that may be used in association with the present invention.

Although, in the above-described embodiment, the nozzles 47 (#A1, A180, B1, B180, . . . V1, and V180) located at the both ends of the nozzles A to V are set as the reference nozzles 47X, the invention is not limited to this.

As shown in FIG. 11A, for example, only the nozzle 47 (#A1) located at one end of the nozzle row A is set as the reference nozzle 47X. That is, at least one reference nozzle 47X may be set, but the precise location of the reference nozzle 47X is not limited.

As shown in FIG. 11B, the nozzles 47 positioned at four corners of the nozzle opening surface 43a, or the nozzles #A1, A180, V1, and V180 that located at each end of the nozzle rows A and V are set as the reference nozzles 47X. In this embodiment, the nozzles 47 located at the four corners of the nozzle opening surface 43a are most susceptible to drying because they are surrounded by a fewer number of other nozzles 47. Without the ink L in the other nozzles 47 to increase the humidity, the inks L in the corner nozzles are most susceptible to thickening.

Moreover, in the previously described embodiment, a portion of the nozzles 47 are defined as the reference nozzles 47X, but the invention is not limited to this configuration. In another embodiment, the reference nozzles 47X may be independent of the nozzles 47 used to discharge the ink droplets D toward the recording paper. For example, as shown in FIG. 11C, the reference nozzles 47X may be formed between the rows of the nozzle rows A to V or, as shown in FIG. 11D, the reference nozzle 47X may be formed in an area, here in the four outside corners, that is outside the nozzle rows A and V.

In addition, although in the previously described embodiment the cap member 15 of the capping mechanism 14 is used as a liquid droplet reception portion, the invention is not limited to this and a liquid droplet reception portion for inspecting the discharge may be separately provided.

Moreover, although the electrode member and the nozzle substrate of the recording head are electrically connected such that the electrode member 78 has the positive polarity and the nozzle substrate 43 of the recording head 3 has the negative polarity in the previously described embodiment; the polarities of the electrode member and the nozzle substrate may be reversed.

In another variation of the previously described embodiment, other pressure generation sources may be used instead of the vertical vibration of the piezoelectric vibrators 38. For example, a piezoelectric vibrator which is capable of vibrating in an electric field direction or lamination direction of the piezoelectric material and internal electrode may be used. Thus, the invention is not limited to a configuration wherein piezoelectric vibrator units are formed for every nozzle row. Thus, a piezoelectric vibrator of the deflection vibration variety may be provided for each pressure chamber 46. In addition, the invention is not limited to piezoelectric vibrators and other pressure generation elements, such as heating elements, may also be used.

Although the invention was described with reference to an ink jet printer embodiment, the invention is not limited to this and a fluid ejecting apparatus for ejecting or discharging liquid, such as liquid in which particles of a functional material are dispersed or fluid such as gel, may also be used.

For example, the invention may also be used in a liquid ejecting apparatus capable of ejecting liquid including a material such as an electrode material or a color material by dispersion or dissolution, such as the apparatuses used for manufacturing liquid crystal displays, electroluminescence (EL) displays, and surface light-emitting displays. Moreover, the invention may be used in liquid ejecting apparatuses for ejecting a bio organic material used for manufacturing bio chips, and in liquid ejecting apparatuses capable of ejecting liquid as a sample, such as in a precise pipette.

In addition, the invention is applicable to liquid ejecting apparatuses capable of ejecting lubricant oil into a precision machine such as a watch or a camera at precise location, and to liquid ejecting apparatuses for ejecting transparent resin liquid, such as ultraviolet curing resin, onto a substrate in order to form a minute semi-spherical lens (optical lens) which may be used in an optical communication device. Moreover, the invention is applicable in a liquid ejecting apparatus capable of ejecting etching liquid, such as acid or alkali, in order to etch a substrate, or a fluid ejecting apparatus for ejecting gel.

Thus, the invention may be applicable to any number of liquid ejecting apparatuses wherein the ejected liquid is susceptible to thickening or drying.

What is claimed is:

1. A flushing method for a liquid ejecting apparatus capable of ejecting liquid from a plurality of nozzles of a liquid ejecting head toward a liquid reception portion which faces a nozzle opening surface of the liquid ejecting head, without contacting the nozzle opening surface, so as to prevent the nozzles from clogging, the method comprising:
creating an electric field between the nozzle opening surface and the liquid reception portion;
ejecting the liquid from a reference nozzle toward the liquid reception portion, the reference nozzle being formed in the nozzle opening surface so as to eject the liquid to only toward the liquid reception portion;
detecting a variation in voltage when the liquid is ejected from the reference nozzle using electrostatic induction;
changing a liquid ejecting condition for ejecting liquid from the nozzles to the liquid reception portion based on the result of the detected variation in voltage; and
ejecting the liquid from the nozzles to the liquid reception portion on based on the liquid ejecting condition.

2. The flushing method according to claim 1, wherein changing of the liquid ejecting condition comprises determining the viscosity of the liquid in the reference nozzle based on the result of the detected variation in voltage.

3. The flushing method according to claim 2, wherein the viscosity of the liquid in the reference nozzle is obtained measuring a variation in the amplitude and/or timing of the detected voltage.

4. The flushing method according to claim 1, wherein changing the liquid ejecting condition comprises changing at least one condition from the group of liquid ejecting conditions comprising the number of times of the liquid is ejected from the nozzles, the amount of liquid ejected from the nozzles, and the periodic time interval between flushing operations.

5. The flushing method according to claim 1, wherein the flushing method is performed before starting an ejection process, wherein liquid is ejected from the liquid ejecting head onto a liquid ejecting object.

6. The flushing method according to claim 1, wherein the flushing method is periodically performed during an ejection process, wherein liquid from the liquid ejecting head is ejected onto a liquid ejecting object.

7. The flushing method according to claim 1, wherein the flushing method is performed when a liquid ejecting object is fed into the liquid ejecting head or when the liquid ejecting object is ejected from the liquid ejecting head.

8. A liquid ejecting apparatus for ejecting liquid from nozzles of a nozzle opening surface of a liquid ejecting head toward a liquid reception portion which faces the nozzle opening surface without contacting the liquid ejecting head, so as to prevent the nozzles from being clogged, the liquid ejecting apparatus comprising:
a reference nozzle which is formed in the nozzle opening surface which is capable of ejecting the liquid only toward the liquid reception portion;
a liquid detecting unit which is capable of creating an electric field between the nozzle opening surface and the liquid reception portion and detecting a variation in voltage based when the liquid is ejected from the reference nozzle to the liquid reception portion using electrostatic induction; and
a flushing processing unit which is capable of changing a liquid ejecting condition for ejecting liquid from the nozzles based on the result of the detected variation in the voltage and is further capable of ejecting the liquid from the nozzles to the liquid reception portion based on the changed liquid ejecting condition.

9. The liquid ejecting apparatus according to claim 8, wherein the flushing processing unit is capable of determining the viscosity of the liquid in the nozzles on based on the detected variation in voltage.

10. The liquid ejecting apparatus according to claim 9, wherein the viscosity of the liquid in the nozzles is determined by measuring a variation in the amplitude and/or timing of the voltage.

11. The liquid ejecting apparatus according to claim 8, wherein the nozzles are arranged into a plurality of rows of nozzles and the reference nozzle is formed in one end or both ends of a row of nozzles.

12. The liquid ejecting apparatus according to claim 11, wherein one reference nozzle is formed for each row of nozzles.

13. The liquid ejecting apparatus according to claim 8, wherein the nozzles are arranged in a grid on the nozzle opening surface and a reference nozzle is formed at each of the four corners of the grid of nozzles on the nozzle opening surface.

14. A method for a preventing a plurality of nozzles in a nozzle opening surface of a liquid ejecting head in a liquid ejecting apparatus from clogging, the method comprising:
causing the nozzle opening to face a liquid reception portion without contacting the liquid reception portion;
creating an electric field between the nozzle opening surface and the liquid reception portion;
ejecting liquid from a reference nozzle in the nozzle opening surface toward the liquid reception portion, the reference nozzle being formed so as to eject the liquid to only toward the liquid reception portion;
detecting a variation in voltage when the liquid is ejected from the reference nozzle using an electrostatic induction process;
determining the viscosity of the liquid ejected from the reference nozzle based the detected variation in voltage;
changing a liquid ejecting condition for ejecting liquid from the nozzles to the liquid reception portion based on the viscosity of the liquid ejected from the reference nozzle; and
ejecting the liquid from the nozzles to the liquid reception portion on based on the liquid ejecting condition.

15. The method according to claim 14, wherein the viscosity of the liquid in the reference nozzle is determined by measuring a variation in the amplitude and/or timing of the detected voltage.

16. The method according to claim 14, wherein changing the liquid ejecting condition comprises changing at least one condition from the group of liquid ejecting conditions comprising the number of times of the liquid is ejected from the nozzles, the amount of liquid ejected from the nozzles, and the periodic time interval between flushing operations.

17. The method according to claim 14, wherein the flushing method is performed before starting an ejection process, wherein liquid is ejected from the liquid ejecting head onto a liquid ejecting object.

18. The method according to claim 14, wherein the flushing method is performed periodically during an ejection process, wherein liquid from the liquid ejecting head is ejected onto a liquid ejecting object.

19. The method according to claim 14, wherein the flushing method is performed when a liquid ejecting object is fed into the liquid ejecting head or when the liquid ejecting object is ejected from the liquid ejecting head.
